(19) United States
(12) Patent Application Publication
(10) Pub. No.: US 2026/0161051 A1
(43) Pub. Date: Jun. 11, 2026

(54) CAMERA MODULE

(71) Applicant: SAMSUNG ELECTRO-MECHANICS CO., LTD., Suwon-si (KR)

(72) Inventor: Sung Hae LEE, Suwon-si (KR)

(21) Appl. No.: 19/268,194

(22) Filed: Jul. 14, 2025

(30) Foreign Application Priority Data
Dec. 5, 2024 (KR) 10-2024-0179239

(51) Int. Cl. G03B 17/02; G03B 30/00

(52) U.S. Cl. CPC G03B 17/02; G03B 30/00

(57) ABSTRACT

A camera module includes a housing, a carrier disposed in the housing and movable in an optical axis direction with respect to the housing, a first frame disposed in the carrier and movable in a direction perpendicular to an optical axis with respect to the carrier, a stopper coupled to the carrier to cover the first frame, and having a first damper, and a case coupled to the housing, and having a receiving portion protruding toward the stopper and a second damper disposed in the receiving portion, wherein the first damper and the second damper face each other in the optical axis direction.

### CROSS-REFERENCE TO RELATED APPLICATIONS

This application claims the benefit under 35 USC 119(a) of Korean Patent Application No. 10-2024-0179239 filed on Dec. 5, 2024, in the Korean Intellectual Property Office, the entire disclosure of which is incorporated herein by reference for all purposes.

### BACKGROUND

### 1. Field

The present disclosure relates to a camera module.

### 2. Description of the Background

A camera may be adopted for use in portable electronic devices such as smartphones, tablet PCs, and laptops.

Most camera modules used in portable electronic devices have functions of autofocusing and optical imaging stabilization.

Meanwhile, as camera modules have various functions, the number of components mounted in the camera module may increase, and sizes and weights of camera modules may also increase accordingly.

For example, due to an increase in the weight due to an increase in a size of the lens within the camera module, there may be a problem in that an amount of impact increases when components collide, causing a jolt when operating for autofocusing and optical imaging stabilization, or increasing deformation or damage when subjected to external impacts.

There is a need for a camera module that can alleviate an impact when a collision between components occurs.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing, a carrier disposed in the housing and movable in an optical axis direction with respect to the housing, a first frame disposed in the carrier and movable in a direction perpendicular to an optical axis with respect to the carrier, a stopper coupled to the carrier to cover the first frame, and having a first damper, and a case coupled to the housing, and having a receiving portion protruding toward the stopper and a second damper disposed in the receiving portion, wherein the first damper and the second damper face each other in the optical axis direction.

The second damper may penetrate the receiving portion.

One side of the second damper may protrude toward the stopper, and the other side of the second damper may be accommodated in the receiving portion.

The other side of the second damper may be disposed inwardly of an outer surface of the case.

A minimum gap between the first damper and the second damper may be narrower than a minimum gap between the first damper and the case.

The first damper may be disposed in at least one of corner regions of the stopper.

The first damper may penetrate the stopper.

One side of the first damper may protrude toward the first frame, and the other side of the first damper may protrude toward the case.

At least one of surfaces of the first damper and the second damper facing each other in the optical axis direction may include a convex surface.

The stopper may further include a third damper, the third damper may face the housing in a direction perpendicular to the optical axis.

The stopper may include a main body disposed to cover the first frame, and a plurality of fastening portions extending in the optical axis direction from each corner region of the main body and coupled to the carrier, wherein the first damper may be disposed in the main body, and the third damper may be disposed in at least one of the plurality of fastening portions.

At least one of the first damper, the second damper, and the third damper may include an elastic material.

The camera module may further include a lens barrel including at least one lens, and coupled to the first frame and movable in a direction perpendicular to the optical axis, wherein the lens barrel and the first frame may be movable in the optical axis direction, together with the carrier.

In another general aspect, a camera module includes a housing unit, a carrier accommodated in the housing unit, a first frame accommodated in the carrier, and coupled to a lens barrel, a stopper coupled to the carrier, and a damper respectively disposed in the housing unit and the stopper, wherein the damper includes a first damper disposed in the stopper and a second damper disposed in the housing unit, wherein the second damper is disposed in a receiving portion included in the housing unit, and at least a portion of the second damper overlaps the first damper in an optical axis direction.

Other features and aspects will be apparent from the following detailed description, the drawings, and the claims.

### BRIEF DESCRIPTION OF DRAWINGS

FIG. 1 is a perspective view of a camera module according to one or more embodiments of the present disclosure.

FIG. 2 is an exploded perspective view of a camera module according to one or more embodiments of the present disclosure.

FIG. 3 is an exploded perspective view of a focus adjustment unit according to one or more embodiments of the present disclosure.

FIG. 4 is an exploded perspective view of a shake correction unit according to one or more embodiments of the present disclosure.

FIG. 5 is a drawing illustrating a case and a stopper according to one or more embodiments of the present disclosure.

FIG. 6 is a cross-sectional view taken along line II-II′ of FIG. 5.

FIG. 7 is a perspective view illustrating a portion of a cross-section taken along line I-I′ of FIG. 1.

FIG. 8 is a drawing illustrating the moment just before a collision occurs between a first damper and a second damper in FIG. 7.

FIG. 9 is a drawing schematically illustrating a cross-sectional shape of the first damper and the second damper for region A of FIG. 7.

FIGS. 10 and 11 are drawings illustrating modified examples of FIG. 9.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Any configuration included in one embodiment of the embodiments disclosed herein may also be included in other embodiments unless stated otherwise.

An aspect of the present disclosure is to provide a camera module having a reduced size of a jolt that may occur during driving for autofocusing or optical imaging stabilization.

An aspect of the present disclosure is to provide a camera module in which a degree of deformation or damage may be alleviated even if a collision between components occurs due to an external impact such as a drop impact, or the like.

A camera module 1000 according to one or more embodiments of the present disclosure may be used to take pictures and videos of an external subject.

A camera module 1000 according to one or more embodiments of the present disclosure may be applied to a portable electronic device such as a smartphone.

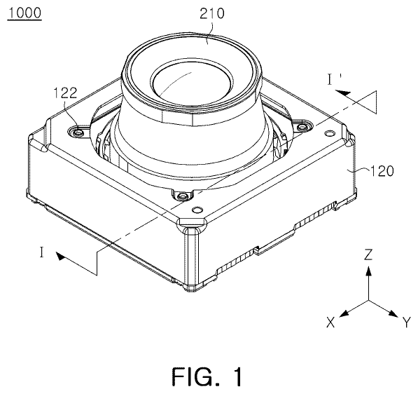

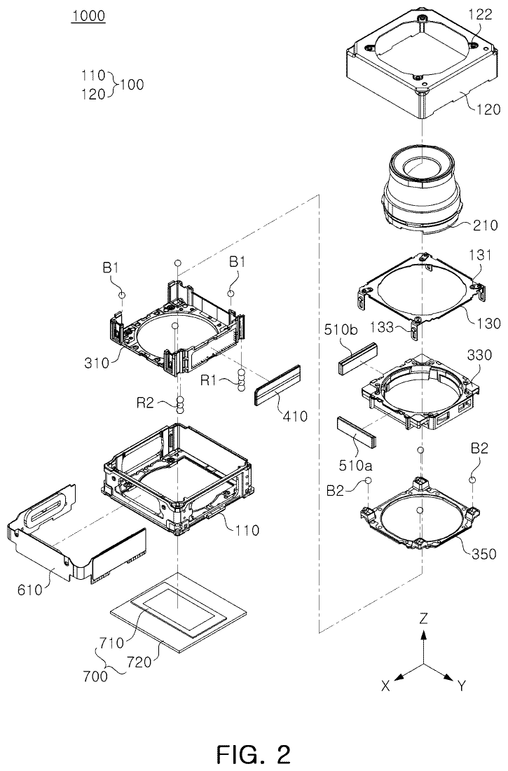

FIG. 1 is a perspective view of a camera module according to one or more embodiments of the present disclosure. FIG. 2 is an exploded perspective view of a camera module according to one or more embodiments of the present disclosure.

Referring to FIGS. 1 and 2, the camera module 1000 according to one or more embodiments of the present disclosure may include a lens barrel 210, a lens driving device for moving the lens barrel 210, an image sensor module 700 converting light incident through the lens barrel 210 into an electric signal, and a housing unit 100 accommodating the lens barrel 210 and the lens driving device.

The housing unit 100 may include a housing 110 and a case 120.

The lens barrel 210 may have a hollow cylindrical shape, and one or more lenses may be disposed inside the lens barrel 210.

A plurality of lenses may be mounted inside the lens barrel 210 in an optical axis (Z-axis) direction. The plurality of lenses may be disposed in a required number, and each lens may have the same or different optical characteristics.

The lens driving device may be a device for moving the lens barrel 210.

The lens driving unit may include a focus adjustment unit 400 and a shake correction unit 500. The focus adjustment unit 400 may adjust a focus of the camera by moving the lens barrel 210 in an optical axis (Z-axis) direction, and the shake correction unit 500 may correct shaking during image capturing by moving the lens barrel 210 in directions (X-axis and Y-axis directions) perpendicular to the optical axis (Z-axis).

The image sensor module 700 may be a device converting light incident through the lens barrel 210 into an electrical signal.

The image sensor module 700 may include an image sensor 710 and a sensor substrate 720 on which the image sensor 710 is mounted.

The image sensor 710 may convert light incident through the lens barrel 210 into an electrical signal. For example, the image sensor 710 can be a Charge Coupled Device (CCD) or a Complementary Metal-Oxide Semiconductor (CMOS).

The electrical signal converted through the image sensor 710 may be output as an image or video through a display unit of the portable electronic device.

The image sensor 710 may be electrically connected to a sensor substrate 720. For example, the sensor substrate 720 may be a printed circuit board (PCB).

A lens barrel 210 and a lens driving device may be accommodated in the housing 110. In one or more embodiments, the housing 110 may have an internal space, and a lens barrel 210 and a lens driving device may be accommodated in the internal space of the housing 110.

In addition, an image sensor module 700 may be disposed in a lower portion of the housing 110. In one or more embodiments, a sensor substrate 720 may be coupled to a bottom surface of the housing 110, and the image sensor 710 may be exposed to the internal space of the housing 110 while the sensor substrate 720 is coupled to the housing 110.

Meanwhile, a main substrate 610 providing a driving signal to a focus adjustment unit 400 and a shake correction unit 500 may be disposed on a side surface of the housing 110. In one or more embodiments, the main substrate 610 may be disposed to surround the side surface of the housing 110.

A driving coil and a position sensor forming the focus adjustment unit 400 and the shake correction unit 500 may be disposed on the main substrate 610.

The housing 110 may include an opening on the side surface, and the driving coil and position sensor may be disposed in the opening and exposed to an internal space of the housing 110.

The case 120 may be coupled to cover the internal space of the housing 110 and can protect components accommodated in the internal space.

In addition, the case 120 may also have a function of shielding electromagnetic waves. To this end, the case 120 may be formed of a metal material and may be grounded to a ground pad included in the sensor substrate 720.

Meanwhile, to reduce a size of a jolt that may occur during driving for autofocusing or optical imaging stabilization, and alleviate a degree of deformation or damage even if a collision occurs between parts due to an external impact such as a drop impact, or the like, the camera module 1000 according to one or more embodiments of the present disclosure may have a damper disposed on each of a stopper 130 and a case 120 inside the camera module.

A first damper 131 may be disposed on the stopper 130, and a second damper 122 may be disposed in the case 120, so that when a movement in an optical axis direction exceeding the limit range due to an external impact, or the like, a collision occurs between the first damper 131 and the second damper 122, thereby alleviating the impact. With such a structure, a buffering effect may be improved as compared to a case in which a direct collision occurs between the damper and an object formed of a hard material.

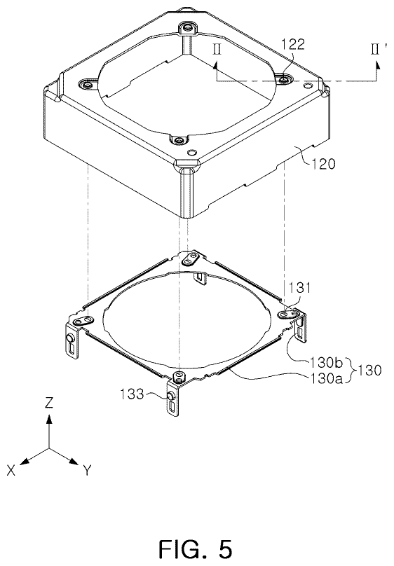

Meanwhile, a structure related to the buffering effect between the second damper 122 of the case 120 and the first damper 131 of the stopper 130 will be described later with reference to FIGS. 5 to 11.

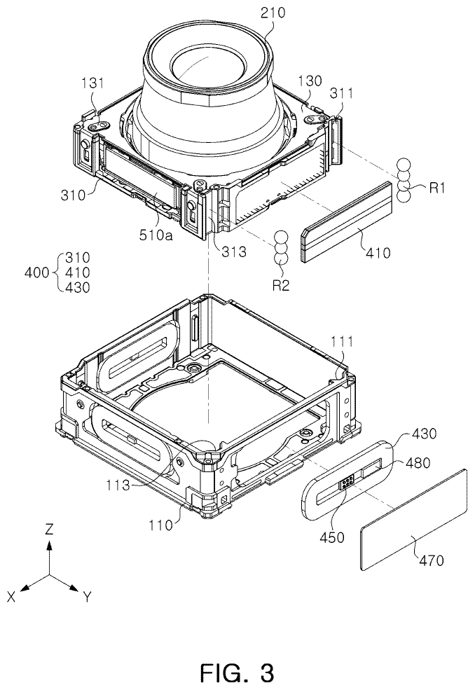

Hereinafter, with reference to FIGS. 2 and 3, a focus adjustment unit 400 among lens driving devices of a camera module 1000 according to one or more embodiments of the present disclosure will be described.

FIG. 3 is an exploded perspective view of a focus adjustment unit according to one or more embodiments of the present disclosure. Meanwhile, in FIG. 3, a main substrate 610 is omitted so that a dispositional relationship between components for driving may be clearly revealed.

According to one or more embodiments of the present disclosure, the focus adjustment unit 400 may include a carrier accommodating the lens barrel 210, and a focus adjustment driving unit generating driving force so that the lens barrel 210 and the carrier 310 may move in an optical axis (Z-axis) direction.

The carrier 310 may accommodate a lens barrel 210, and may be accommodated in an internal space of the housing 110.

The carrier 310 may be moved in the optical axis (Z-axis) direction with respect to the housing 110, together with the lens barrel 210 by driving force generated by a focus adjustment driving unit.

The focus adjustment driving unit may include a focus adjustment magnet 410 and a focus adjustment coil 430.

A focus adjustment magnet 410 may be disposed on one side surface of the carrier 310, and a focus adjustment coil 430 may be disposed on one side surface of the housing 110 through the main substrate 610.

For example, the focus adjustment coil 430 may be disposed on one side surface of the housing 110 facing one side surface of the carrier 310 on which the focus adjustment magnet 410 is disposed.

The focus adjustment magnet 410 and the focus adjustment coil 430 may face each other in a direction perpendicular to the optical axis (Z-axis), and the focus adjustment magnet 410 and the focus adjustment coil 430 may face each other directly through an opening of the housing 110.

When power is applied to the focus adjustment coil 430, the carrier 310 may be moved in the optical axis (Z-axis) direction by an electromagnetic force between the focus adjustment magnet 410 and the focus adjustment coil 430.

The focus adjustment magnet 410 may be a moving member moved in the optical axis (Z-axis) direction, together with the carrier 310, and the focus adjustment coil 430 may be a fixed member fixedly disposed in the housing 110. However, one or more embodiments thereof are not limited thereto, and positions of the focus adjustment magnet 410 and the focus adjustment coil 430 may be interchangeable.

When the carrier 310 is moved, rolling members R1 and R2 may be disposed between the carrier 310 and the housing 110 to reduce friction between the carrier 310 and the housing 110. For example, the rolling members R1 and R2 may be a plurality of ball members.

The rolling members R1 and R2 may be respectively disposed on both sides of the focus adjustment magnet 410.

The number of rolling members R1 disposed on one side of the focus adjustment magnet 410 may be greater than the number of rolling members R2 disposed on the other side thereof. In this case, the rolling member R1 disposed on one side of the focus adjustment magnet 410 may function as a main guide, and the rolling member R2 disposed on the other side of the focus adjustment magnet 410 may function as an auxiliary guide.

The carrier 310 may include first guide grooves 311 and 313 in which a portion of the rolling members R1 and R2 are accommodated on both sides of the focus adjustment magnet 410, respectively.

The first guide grooves 311 and 313 may extend in the optical axis (Z-axis) direction, and each rolling member R1 disposed on the one side of the focus adjustment magnet 410 may contact the first guide groove 311 at two points, and each rolling member R2 disposed on the other side of the focus adjustment magnet 410 may contact the first guide groove 313 at one point.

Second guide grooves 111 and 113 may be formed in the housing 110 to face the first guide grooves 311 and 313, respectively. Other portions of the rolling members R1 and R2 may be accommodated in the second guide grooves 111 and 113.

The second guide grooves 111 and 113 may extend in the optical axis (Z-axis) direction, similar to the first guide grooves 311 and 313. In addition, each rolling member R1 disposed on the one side of the focus adjustment magnet 410 may contact the second guide groove 111 at two points, and each rolling member R2 disposed on the other side of the focus adjustment magnet 410 may also contact the second guide groove 113 at two points.

An outer surface of the main substrate 610 may have a first yoke 470 disposed thereon. The first yoke 470 may correspond to a magnetic material. In FIG. 3, a main substrate may be omitted, and a focus adjustment coil 430 may be disposed on one surface of the main substrate 610 of FIG. 2, and a first yoke 470 may be disposed on the other surface thereof.

The first yoke 470 may face the focus adjustment magnet 410 with the focus adjustment coil 430 interposed therebetween, and thus the first yoke 470 and the focus adjustment magnet 410 may face each other in a direction perpendicular to the optical axis (Z-axis).

Magnetic force may be applied between the first yoke 470 and the focus adjustment magnet 410 in a direction facing each other, that is, in a direction perpendicular to the optical axis (Z-axis).

Accordingly, the carrier 310 may be supported in close contact with the housing 110 in a direction perpendicular to the optical axis (Z-axis), and the rolling members R1 and R2 may be maintained in contact with the carrier 310 and the housing 110.

In addition, the first yoke 470 may also focus magnetic force generated by the focus adjustment magnet 410, by forming a magnetic circuit with the focus adjustment magnet 410.

In addition, in one or more embodiments, the focus adjustment unit 400 may further include a second yoke 480, and the second yoke 480 may be disposed relatively closer to the rolling member R1, functioning as a main guide, to provide additional force, thereby more stably supporting to be in close contact with between the carrier 310 and the housing 110.

According to one or more embodiments of the present disclosure, the focus adjustment unit 400 may use a closed loop control method which detects and feedbacks a position of the lens barrel 210. To this end, the focus adjustment unit 400 may include a first position sensor 450.

The first position sensor 450 may detect the position of the lens barrel 210 in the optical axis direction (Z-axis direction).

The first position sensor 450 may be disposed on one side surface of the housing 110 through the main board 610 together with the focus adjustment coil 430. The first position sensor 450 may be disposed on the inner or outer side of the focus adjustment coil 450.

The first position sensor 450 may be a magnetic sensor, for example, a Hall sensor. However, one or more embodiments thereof are not limited thereto, and first position sensor 450 may be implemented as another type of sensor, such as a gyroscope or an accelerometer.

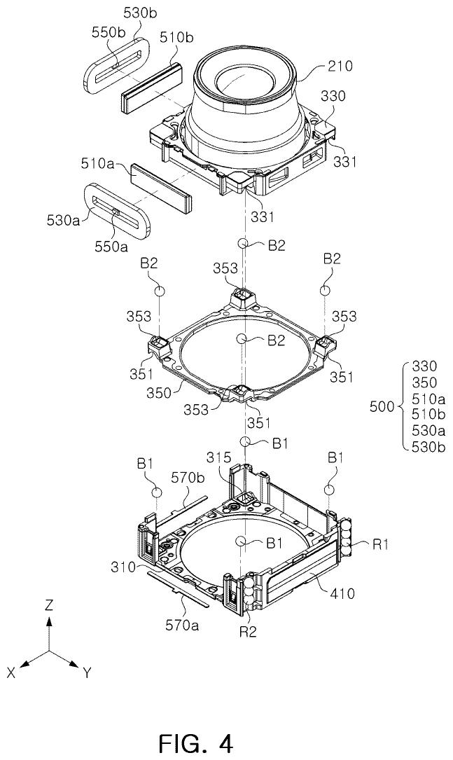

Next, with reference to FIGS. 2 and 4, a shake correction unit 500 among lens driving devices of a camera module 1000 according to one or more embodiments of the present disclosure will be described.

FIG. 4 is an exploded perspective view of a shake correction unit according to one or more embodiments of the present disclosure. Meanwhile, In FIG. 4, the main substrate 610 is omitted so that a dispositional relationship between components for driving may be clearly illustrated.

When shaking occurs due to user hand-shaking, or the like, when shooting a video, or the like, the shake correction unit 500 may compensate for the shaking by providing relative displacement corresponding to the shaking to the lens barrel 210.

According to one or more embodiments of the present disclosure, the shake correction unit 500 may include a first frame 330 and a second frame 350, for guiding a movement of the lens barrel 210, and a shake correction driving unit generating driving force for moving the first frame 330 and the second frame 350 in directions (X-axis and Y-axis directions) perpendicular to the optical axis (Z-axis).

The first frame 330 and the second frame 350 may be accommodated in the carrier 310. In one or more embodiments, first frame 330 and the second frame 350 may be accommodated in the carrier 310 in sequence in the optical axis (Z-axis) direction.

In addition, a lens barrel 210 may be inserted into and fixed in the first frame 330.

The first frame 330 and the second frame 350 may be moved in the directions (X-axis and Y-axis directions) perpendicular to the optical axis (Z-axis) with respect to the carrier 310, together with the lens barrel 210 by driving force generated by the shake correction driving unit.

One of the first frame 330 and the second frame 350 may be moved in a first axis (X-axis) direction perpendicular to the optical axis (Z-axis), and the other thereof may be moved in a second axis (Y-axis) direction perpendicular to both the optical axis (Z-axis) and the first axis (X-axis).

The shake correction driving unit may include a shake correction magnet and a shake correction coil.

The shake correction driving unit may include a first magnet 510a and a first coil 530a generating driving force in a first axis (X-axis) direction, and a second magnet 510b and a second coil 530b generating driving force in a second axis (Y-axis) direction.

The first magnet 510a and the second magnet 510b may be divided and disposed on two mutually perpendicular side surfaces of the first frame 330. Therefore, the first frame 330 may be moved in the first axis (X-axis) direction and the second axis (Y-axis) direction.

Meanwhile, the first coil 530a and the second coil 530b may be disposed in the housing 110 through a main substrate 610. For example, the first coil 530a and the second coil 530b may be disposed on two side surfaces of the housing 110 facing, respectively, two mutually perpendicular side surfaces of the first frame 330 on which the first magnet 510a and the second magnet 510b are disposed.

The shake correction magnet and the shake correction coil may generate driving force in a direction facing each other.

Accordingly, the first magnet 510a and the first coil 530a may be disposed to face each other in the first axis (X-axis) direction, and the second magnet 510b and the second coil 530b may be disposed to face each other in the second axis (Y-axis) direction.

Meanwhile, the first magnet 510a and the second magnet 510b may be moving members moving in the directions (X-axis and Y-axis directions) perpendicular to the optical axis (Z-axis) together with the first frame 330, and the first coil 530a and the second coil 530b may be fixed members fixedly disposed in the housing 110. However, one or more embodiments thereof are not limited thereto, and positions of the first magnet 510a and the first coil 530a and positions of the second magnet 510b and the second coil 530b may be interchangeable.

According to one or more embodiments of the present disclosure, a plurality of ball members may be disposed between the first frame 330 and the second frame 350, and between the second frame 350 and the carrier 310.

The plurality of ball members may guide a movement of the first frame 330 and/or the second frame 350 and maintain a gap between the first frame 330 and the second frame 350, and between the second frame 350 and the carrier 310.

The plurality of ball members may include a first ball member B1 disposed between the second frame 350 and the carrier 310. For example, the first ball member B1 may include three or three or more ball members.

The first ball member B1 may guide a movement of the second frame 350 in the first axis (X-axis) direction.

Since the first frame 330 is supported by the second frame 350, and the lens barrel 210 is fixed to the first frame 330, when the second frame 350 moves in the first axis (X-axis) direction, the lens barrel 210 and the first frame 330 may move in the first axis (X-axis) direction together with the second frame 350.

The second frame 350 may include a third guide groove 351 in which a portion of the first ball member B1 is accommodated on a surface facing the carrier 310 in the optical axis (Z-axis) direction.

In addition, the carrier 310 may have a fourth guide groove 315 in which the other portion of the first ball member B1 is accommodated may be formed on a surface facing the second frame 350 in the optical axis (Z-axis) direction. The fourth guide groove 315 may face the third guide groove 351 in the optical axis (Z-axis) direction.

The third guide groove 351 and the fourth guide groove 315 may extend in the first axis (X-axis) direction. Therefore, when driving force in the first axis (X-axis) direction is generated, the first ball member B1 may roll along the third guide groove 351 and the fourth guide groove 315 in the first axis (X-axis) direction, and the movement thereof in the second axis (Y-axis) may be restricted.

The plurality of ball members may include a second ball member B2 disposed between the first frame 330 and the second frame 350. For example, the second ball member B2 may include three or more ball members.

The second ball member B2 may guide the movement of the first frame 330 in the second axis (Y-axis) direction.

Since the lens barrel 210 is fixed to the first frame 330, when the first frame 330 moves in the second axis (Y-axis) direction, the lens barrel 210 may move in the second axis (Y-axis) direction together with the first frame 330. The first frame 330 may include a fifth guide groove 331 in which a portion of the second ball member B2 is accommodated on a surface facing the second frame 350 in the optical axis (Z-axis) direction.

In addition, the second frame 350 may have a sixth guide groove 353 in which the other portion of the second ball member B2 is accommodated may be formed on a surface facing the first frame 330 in the optical axis (Z-axis) direction. The sixth guide groove 353 may face the fifth guide groove 331 in the optical axis (Z-axis) direction.

The fifth guide groove 331 and the sixth guide groove 353 may extend in the second axis (Y-axis) direction.

Therefore, when driving force is generated in the second axis (Y-axis) direction, the second ball member B2 may roll along the fifth guide groove 331 and the sixth guide groove 353 in the second axis (Y-axis) direction, and the movement thereof in the first axis (X-axis) direction may be restricted.

Meanwhile, in another embodiment, the second frame 350 may be omitted, and the first frame 330 may be accommodated in the carrier 310 while being fixed to the lens barrel 210.

In this case, the plurality of ball members disposed between the first frame 330 and the carrier 310 may roll in the first-axis (X-axis) direction when driving force in the first-axis (X-axis) direction is generated, and may roll in the second-axis (Y-axis) direction when driving force in the second-axis (Y-axis) direction is generated.

In addition, to this end, the guide groove formed on the surface of the first frame 330 and the carrier 310 facing each other in the optical axis (Z-axis) direction may have a shape not limiting the movement direction of the plurality of ball members on a plane perpendicular to the optical axis (Z-axis).

According to one or more embodiments of the present disclosure, a plurality of yokes 570a and 570b may be disposed in the carrier 310. In one or more embodiments, the plurality of yokes 570a and 570b may correspond to a magnetic body.

The plurality of yokes 570a and 570b may be disposed to face the first magnet 510a and the second magnet 510b disposed in the first frame 330 in the optical axis direction (Z-axis direction).

Magnetic attraction may be applied between the plurality of yokes 570a and 570b and the first magnet 510a and the second magnet 510b in a direction facing each other, that is, in an optical axis (Z-axis) direction. Therefore, the first frame 330 and the second frame 350 may be pressed against the carrier 310 in the optical axis (Z-axis) direction, and the first ball member B1 and the second ball member B2 may maintain a state of contact with the first frame 330, the second frame 350, and the carrier 310, respectively.

According to one or more embodiments of the present disclosure, the shake correction unit 500 may use a closed-loop control method which detects and feeds back a position of the lens barrel 210. To this end, the shake correction unit 500 may include a second position sensor 550a and a third position sensor 550b. The second position sensor 550a and the third position sensor 550b may detect the positions of the lens barrel 210 in the first axis direction (X-axis direction) and the second axis direction (Y-axis direction).

The second position sensor 550a and the third position sensor 550b may be disposed on one side of the housing 110 through the main board 610 together with the first coil 530a and the second coil 530b, respectively. In one or more embodiments, the second position sensor 550a and the third position sensor 550b may be disposed on the inner side or outer side of the first coil 530a and the second coil 530b.

The second position sensor 550a and the third position sensor 550b may be magnetic sensors, for example, Hall sensors. However, one or more embodiments thereof are not limited thereto, and the second position sensor 550a and the third position sensor 550b may also be implemented as other types of sensors, such as a gyroscope or an accelerometer.

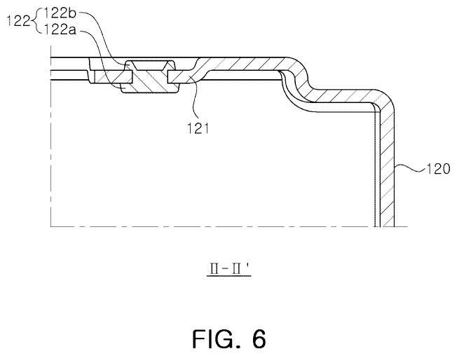

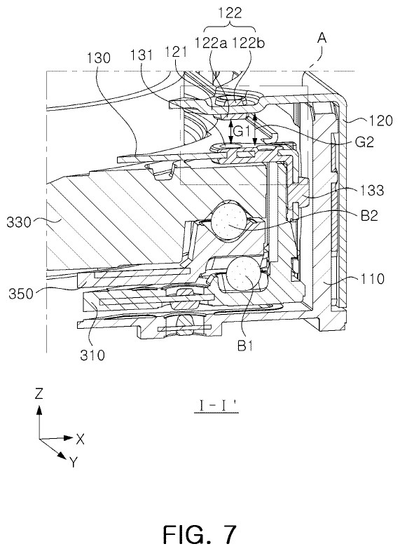

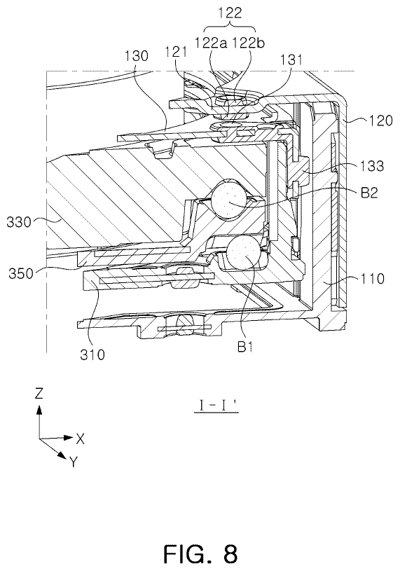

FIG. 5 is a drawing illustrating a case 120 and a stopper 130 according to one or more embodiments of the present disclosure. FIG. 6 is a cross-sectional view taken along line II-II′ of FIG. 5. FIG. 7 is a perspective view illustrating a partial cross-section taken along line I-I′ of FIG. 1. FIG. 8 is a drawing illustrating the moment just before a collision occurs between the first damper 131 and the second damper 122 in FIG. 7.

The camera module 1000 according to one or more embodiments of the present disclosure may further include a stopper 130 to absorb impacts transmitted to internal components due to an external impact, or the like, and prevent the first frame 330 and the second frame 350 from being deviated from a carrier 310. The stopper 130 according to one or more embodiments may include a first damper 131 to increase a buffering effect between the case 120 and the first frame 330.

Referring to FIGS. 2, 5 and 7, the stopper 130 may be coupled to the carrier 310 to cover at least a portion of an upper surface of the first frame 330.

The stopper 130 may include a main body 130a disposed to cover the upper surface of the first frame 330, and a fastening portion 130b extending in an optical axis (Z-axis) direction from each corner portion of the main body 130a.

The fastening portion 130b may be respectively disposed on both ends of two sides facing each other in the first axis (X-axis) direction of the main body 130a for coupling with carrier 310. The stopper 130 may be coupled to the carrier 310 through the fastening portion 130b. The fastening portion 130b may be inserted into a groove formed in the carrier 310 and fixed.

The stopper 130 may cover the first frame 330 and the second frame 350 accommodated in an internal space of the carrier 310, and since the stopper 130 is coupled to the carrier 310, the first frame 330 and the second frame 350 received in the internal space of the carrier 310 may be prevented from being deviated from the carrier 310 due to an external impact, or the like.

The stopper 130 may include a damper for absorbing impacts transmitted to the components when an external impact occurs. Specifically, the stopper 130 may include a first damper 131 for buffering in an optical axis direction (Z-axis direction), and a third damper 133 for buffering in a direction perpendicular to an optical axis (X-axis direction).

The first damper 131 may be disposed in at least one of corner regions of the stopper 130. Preferably, the first damper 131 may be disposed in each corner region of the stopper 130. When the first damper 131 is disposed in each corner region of the stopper 130, an impact amount may be appropriately distributed during a buffering operation, and a buffering range may be expanded.

The first damper 131 may be disposed to penetrate the stopper 130. For example, the first damper 131 may be inserted into a hole formed in the main body 130a of the stopper 130 in the optical axis direction (Z-axis direction). However, one or more embodiments thereof are not limited thereto, and the first damper 131 may be coupled to the stopper 130 through an insert injection process, or the first damper 131 and the stopper 130 may be manufactured separately, and then the first damper 131 may be bonded to the stopper 130 using an adhesive or the like.

A first damper 131 may be disposed to protrude from both surfaces of the stopper 130. Specifically, one side of the first damper 131 may protrude toward the first frame 330, and the other side of the first damper 131 may protrude toward the case 120. More specifically, the other side of the first damper 131 may protrude toward the second damper 122 disposed in the case 120.

As the first damper 131 protrudes in both directions in the optical axis direction (Z-axis direction) through the stopper 130, when an impact in the optical axis direction (Z-axis direction) is applied to the camera module 1000, the first damper 131 may contact the second damper 122 disposed in the case 120 upwardly (in a +z direction) of the stopper 130, and contact the first frame 330 downwardly (in a −z direction) thereof. The first damper 131 disposed on the stopper 130 may limit the range of movement of the carrier 310 in the optical axis direction (Z-axis direction) and prevent a direct collision between the stopper 130 and the case 120. Furthermore, the second damper 122 disposed in the case 120 may also prevent a direct collision between the first damper 131 and the case 120. Accordingly, the camera module 1000 according to the present embodiment may minimize the occurrence of damage or jolt due to an impact.

The stopper 130 may further include a third damper 133 disposed to face the housing 110 in a first axis (X-axis) direction perpendicular to the optical axis (Z-axis). Accordingly, when an impact is applied to the camera module 1000 in the first axis (X-axis) direction, a direct collision between the housing 110 and the first frame 330 may be prevented by the third damper 133.

However, a dispositional direction of the third damper 133 is not limited thereto, and may be disposed in a second axis (Y-axis) direction, perpendicular to both the optical axis (Z-axis) and the first axis (X-axis).

The third damper 133 may be disposed in at least one of the plurality of fastening portions 130b included in the stopper 130. Preferably, the third damper 133 may be disposed in each fastening portion 130b of the stopper 130. When the third damper 133 is disposed in each fastening portion 130b of the stopper 130, an impact amount may be appropriately distributed during a buffering operation in a direction perpendicular to the optical axis (Z-axis), and a buffering range may be expanded.

A first damper 131 and a third damper 133 disposed on the stopper 130 may be integrally formed. However, one or more embodiments thereof are not limited thereto and the first damper 131 and the third damper 133 may be separate components, which are separated, respectively. When the first damper 131 and the third damper 133 are formed integrally, a coupling force with the stopper 130 may be strengthened.

Meanwhile, the camera module 1000 according to one or more embodiments of the present disclosure may implement a collision structure between dampers by disposing a second damper 122 in the case 120 to further increase a buffering effect compared to a case in which a direct collision occurs between a first damper 131 formed of an elastic material and a case 120 formed of a hard material.

Hereinafter, with reference to FIGS. 5 to 8, a second damper 122 disposed in a case 120 according to one or more embodiments of the present disclosure will be described in detail.

FIG. 5 is a drawing illustrating a coupling relationship between a case 120 and a stopper 130 according to one or more embodiments of the present disclosure, and other components are omitted from the illustration for convenience of explanation.

Referring to FIGS. 2 and 5, the case 120 may be coupled to the housing 110. Specifically, the case 120 may be coupled to the housing 110 in an optical axis (Z-axis) direction to cover an internal space of the housing 110.

In addition, the case 120 may include a receiving portion 121 protruding in the optical axis (Z-axis) direction toward the stopper 130, and a second damper 122 disposed in the receiving portion 121. The receiving portion 121 refers to a region formed in the case 120 for receiving the second damper 122, and may be formed to protrude downwardly (in a −z direction) and concave upwardly (in a +z direction).

The second damper 122 disposed in the receiving portion 121 may be disposed to face the first damper 131 disposed in the stopper 130 in the optical axis (Z-axis) direction. At least a portion of the second damper 122 may overlap the first damper 131 in the optical axis (Z-axis) direction.

According to one or more embodiments of the present disclosure, the camera module 1000 may improve a buffering effect by causing a collision between the first damper 131 and the second damper 122 when an external force in the optical axis (Z-axis) direction is received, due to a dropping impact, or the like, through the structure described above. When only one of the first damper 131 and the second damper 122 is disposed, since a colliding object is a hard material (e.g., a stainless steel material, or the like) such as the first frame 330, the case 120, or the like, the buffering effect may be low compared to the collision structure between the first damper 131 and the second damper 122 of the present embodiment.

FIG. 6 is a cross-sectional view taken along line II-II′ of FIG. 5.

Referring to FIGS. 5 and 6, a receiving portion 121 may have a shape protruding in the optical axis (Z-axis) direction toward the stopper 130. That is, among outer surfaces of the case 120, a receiving portion 121 may be formed to be concave on an upper surface thereof based on the direction of FIG. 6. Accordingly, even if a second damper 122 is received within the receiving portion 121, it may not protrude externally, a thickness of the case 120 in the optical axis (Z-axis) direction may be maintained, which may be advantageous for miniaturization.

A second damper 122 may be accommodated in the receiving portion 121, and the second damper 122 may be disposed to penetrate the receiving portion 121.

One side 122a of the second damper may protrude toward the stopper 130, and the other side 122b of the second damper may be disposed to be accommodated within the receiving portion.

In addition, the other side 122b of the second damper may be disposed inwardly of the outer surface of the case 120. That is, based on the direction of FIG. 6, a height of the other side 122b of the second damper may be disposed lower than a height of the upper surface of the case 120. Accordingly, the other side 122b of the second damper may not protrude further than the outer surface of the case 120.

At least one of the first damper 131, the second damper 122, and the third damper 133 may include an elastic material. At least one of the first damper 131, the second damper 122, and the third damper 133 may include an elastic material or a soft material having a high buffering effect, such as, rubber or a foam material, but one or more embodiments thereof are not limited.

FIG. 7 is a perspective view illustrating a portion of a cross-section taken along line I-I′ of FIG. 1.

Referring to FIG. 7, a minimum gap G1 between the first damper 131 disposed on the stopper 130 and the second damper 122 disposed on the case 120 may be narrower than a minimum gap G2 between the first damper 131 and the case 120. Accordingly, when a carrier 310 moves beyond the limit range in the optical axis (Z-axis) direction due to driving for autofocusing or an external impact, the first damper 131 disposed in the stopper 130 may first be in contact with the second damper 122 formed of an elastic material rather than the case 120 formed of a hard material, thereby increasing the buffering effect.

FIG. 8 is a drawing illustrating the moment just before a collision occurs between the first damper 131 and the second damper 122 in FIG. 7.

Referring to FIG. 8, when a carrier 310 moves upwardly (in a +z direction) within the housing 110, a gap between the first damper 131 disposed on the stopper 130 and the second damper 122 disposed in the case may be narrowed, and when a movement exceeding the limit range occurs, the first damper 131 and the second damper 122 may collide with each other, thereby effectively alleviating impacts received by the internal components.

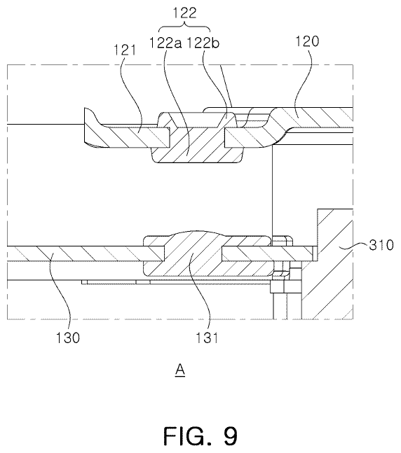

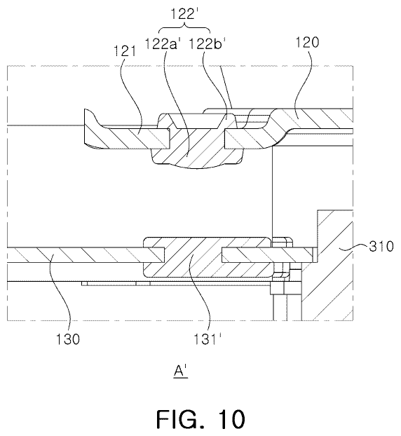

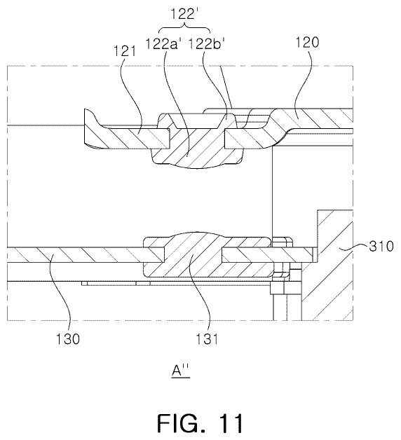

FIG. 9 is a drawing schematically illustrating a cross-sectional shape of the first damper 131 and the second damper 122 for region A of FIG. 7. FIGS. 10 and 11 are drawings illustrating modified examples of FIG. 9.

Referring to FIGS. 9 to 11, in the camera module 1000 according to one or more embodiments of the present disclosure, at least one of surfaces of a first damper 131 and a second damper 122, facing each other in the optical axis (Z-axis) direction may include a convex surface.

Since the first damper 131 and the second damper 122 may include an elastic material, when the surfaces of the first damper 131 and the second damper 122 facing each other are both flat surfaces, problems in which adhesion occurs during a process of returning to an original position thereof after a collision, which delays the time it takes to return to the original position, or in which the first damper 131 and the second damper 122 remain while being in contact with each other, may occur. Accordingly, at least one of the surfaces of the first damper 131 and the second damper 122 facing each other in the optical axis (Z-axis) direction may be formed to be convex to solve the above-described problems.

Referring to FIG. 9, based on the direction of FIG. 9, an upper surface of the first damper 131 disposed on the stopper 130 may include a convex surface. In addition, one side 122a, i.e., a lower surface, of the second damper disposed in the case 120 may be formed to have a flat surface. Through such a structure, even if a contact occurs due to a collision between the first damper 131 and the second damper 122, it may be rapidly returned to the original position without a problem such as adhesion, or the like.

Referring to FIG. 10, based on the direction of FIG. 10, one side 122a′, i.e., of a second damper disposed in the case 120, i.e., a lower surface thereof may have a convex surface. In addition, an upper surface of a first damper 131′ disposed on the stopper 130 may be formed to have a flat surface. Through this structure, even if a contact occurs due to a collision between the first damper 131′ and the second damper 122′, it may be rapidly returned to the original position without a problem such as adhesion, or the like.

Referring to FIG. 11, based on the direction of FIG. 11, each of the upper surface of the first damper 131 disposed on the stopper 130 and one side 122a′, i.e., the lower surface, of the second damper disposed in the case 120 may include a convex surface. Through this structure, even if a contact occurs due to a collision between the first damper 131 and the second damper 122′, it may be rapidly returned to the original position without a problem such as adhesion, or the like.

As set forth above, according to one or more embodiments of the present disclosure, a camera module may reduce a size of a jolt that may occur during driving for autofocusing or optical imaging stabilization.

In addition, in a camera module according to one or more embodiments of the present disclosure, even if a collision occurs between parts due to an external impact such as dropping, or the like, a degree of deformation or damage may be alleviated.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a housing;
a carrier disposed in the housing and movable in an optical axis direction with respect to the housing;
a first frame disposed in the carrier and movable in a direction perpendicular to an optical axis with respect to the carrier;
a stopper coupled to the carrier to cover the first frame, and having a first damper; and
a case coupled to the housing, and having a receiving portion protruding toward the stopper and a second damper disposed in the receiving portion,
wherein the first damper and the second damper face each other in the optical axis direction.

2. The camera module of claim 1, wherein the second damper penetrates the receiving portion.

3. The camera module of claim 1, wherein one side of the second damper protrudes toward the stopper, and the other side of the second damper is accommodated in the receiving portion.

4. The camera module of claim 3, wherein the other side of the second damper is disposed inwardly of an outer surface of the case.

5. The camera module of claim 1, wherein a minimum gap between the first damper and the second damper is narrower than a minimum gap between the first damper and the case.

6. The camera module of claim 1, wherein the first damper is disposed in at least one of corner regions of the stopper.

7. The camera module of claim 1, wherein the first damper penetrates the stopper.

8. The camera module of claim 1, wherein one side of the first damper protrudes toward the first frame, and the other side of the first damper protrudes toward the case.

9. The camera module of claim 1, wherein at least one of surfaces of the first damper and the second damper facing each other in the optical axis direction comprises a convex surface.

10. The camera module of claim 1, wherein the stopper further comprises a third damper, the third damper facing the housing in a direction perpendicular to the optical axis.

11. The camera module of claim 10, wherein the stopper comprises a main body disposed to cover the first frame, and a plurality of fastening portions extending in the optical axis direction from each corner region of the main body and coupled to the carrier,
wherein the first damper is disposed in the main body, and the third damper is disposed in at least one of the plurality of fastening portions.

12. The camera module of claim 10, wherein at least one of the first damper, the second damper, and the third damper comprises an elastic material.

13. The camera module of claim 1, further comprising:
a lens barrel comprising at least one lens, and coupled to the first frame and movable in a direction perpendicular to the optical axis,
wherein the lens barrel and the first frame are movable in the optical axis direction, together with the carrier.

14. A camera module, comprising:
a housing unit;
a carrier accommodated in the housing unit;
a first frame accommodated in the carrier, and coupled to a lens barrel;
a stopper coupled to the carrier;
a damper respectively disposed in the housing unit and the stopper,
wherein the damper comprises a first damper disposed in the stopper and a second damper disposed in the housing unit,
wherein the second damper is disposed in a receiving portion included in the housing unit, and at least a portion of the second damper overlaps the first damper in an optical axis direction.

15. The camera module of claim 14, wherein a minimum gap between the first damper and the second damper is narrower than a minimum gap between the first damper and the housing unit.

16. The camera module of claim 14, wherein one side of the second damper protrudes toward the stopper, and the other side of the second damper is accommodated in the receiving portion.
